(19) United States
(12) Patent Application Publication
(10) Pub. No.: US 2016/0007119 A1
(43) Pub. Date: Jan. 7, 2016

(54) Diaphragm Stiffener

(71) Applicant: Knowles Electronics, LLC, Itasca, IL (US)

(72) Inventor: Brandon Harrington, Chicago, IL (US)

(21) Appl. No.: 14/683,360

(22) Filed: Apr. 10, 2015

Related U.S. Application Data
(60) Provisional application No. 61/983,161, filed on Apr. 23, 2014.

(51) Int. Cl. H04R 7/00; H04R 1/08

(52) U.S. Cl. CPC H04R 7/00; H04R 1/08; H04R 2201/003

(57) ABSTRACT

A diaphragm for deployment in a micro electro mechanical system (MEMS) microphone includes a base portion. The base portion is generally planar and has a first side and a second side. One or more protrusions are formed with and extend from the base portion. The protrusions are configured and arranged so as to stiffen the base portion and increase a range of sound pressure levels before distortion occurs.

### CROSS REFERENCES TO RELATED APPLICATION

This patent claims benefit under 35 U.S.C. §119 (e) to U.S. Provisional Application No. 61/983,161 entitled “Diaphragm Stiffener” filed Apr. 23, 2014, the content of which is incorporated herein by reference in its entirety.

### TECHNICAL FIELD

This application relates to acoustic devices and, more specifically, to the diaphragms used by these devices.

### BACKGROUND OF THE INVENTION

Various types of acoustic devices have been used over the years. One example of an acoustic device is a microphone. Generally speaking, a microphone converts sound waves into an electrical signal. Microphones sometimes include multiple components that include micro-electro-mechanical systems (MEMS) and integrated circuits (e.g., application specific integrated circuits (ASICs)). A MEMS die typically has disposed on it a diaphragm and a back plate. Changes in sound energy move the diaphragm, which changes the capacitance involving the back plate thereby creating an electrical signal. The MEMS dies is typically disposed on a base or substrate along with the ASIC and then both are enclosed by a lid or cover.

As mentioned, the above approaches use a diaphragm. The diaphragms are generally constructed from flexible materials such as flexible membranes. Current diaphragms are constructed as single-piece entities. However, with current diaphragms, there are limits to the sensitivities and input sound pressures that the diaphragms can achieve.

For example, it is often desired that the acoustic devices operate in high pressure regions. However, because of the high sensitivities of the diaphragms, it often proves difficult to operate conventional diaphragms in these regions.

Previous approaches have not been successful in extending the utility of diaphragms. Because of the above-mentioned limitations, some user dissatisfaction has resulted from these previous approaches.

### BRIEF DESCRIPTION OF THE DRAWINGS

For a more complete understanding of the disclosure, reference should be made to the following detailed description and accompanying drawings wherein:

FIG. 1 comprises a side cutaway view of a top port microphone according to various embodiments of the present invention;

FIG. 2 comprises a side cutaway view of a bottom port microphone according to various embodiments of the present invention;

FIG. 3A comprises a diagram showing the creating of a stiffener with a diaphragm according to various embodiments of the present invention;

FIG. 3B comprises a flow chart showing the process for creating a stiffener that corresponds to the diagram shown in FIG. 3A according to various embodiments of the present invention;

FIG. 3C comprises a diagram showing a close-up views of the stiffener with the diaphragm according to various embodiments of the present invention;

FIG. 4 comprises a top view of a diaphragm with a stiffener according to various embodiments of the present invention;

FIG. 5 comprises close-up view of portions of the diaphragm shown in FIG. 4 according to various embodiments of the present invention;

FIG. 6 comprises a graph showing some of the advantages of the present approaches including linear response at high sound pressures according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Approaches are described provide microphones having a linear operation in the larger acoustic pressure ranges of acoustic devices. These approaches do not require additional process steps during manufacturing. Further, the diaphragms so-provided can operate across a greater operating range than previously possible.

In many of these embodiments, a diaphragm for deployment in a micro electro mechanical system (MEMS) microphone includes a base portion. The base portion is generally planar and has a first side and a second side. One or more protrusions are formed with and extend from the base portion. The protrusions are configured and arranged so as to stiffen the base portion and increase a range of sound pressure levels before distortion occurs. In one aspect, these approaches allows a greater range of sound pressure levels to be utilized before sound distortion occurs.

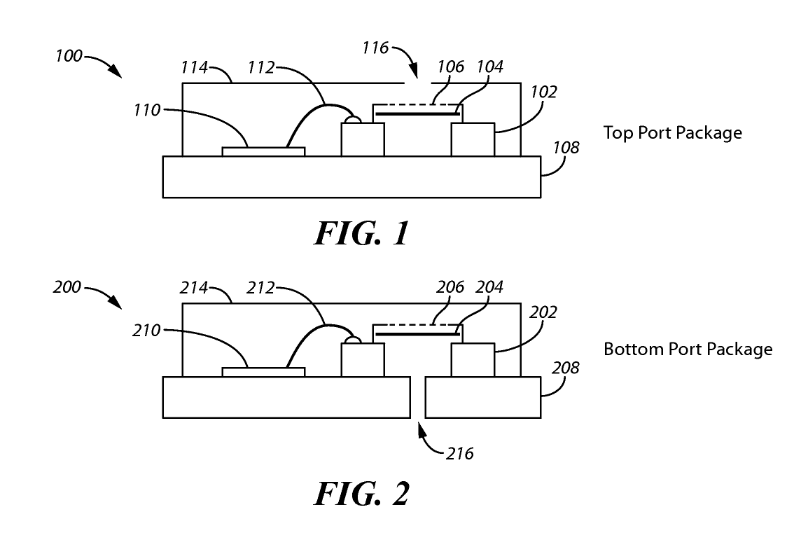

Referring now to FIG. 1, one example of a microphone 100 is described. The microphone 100 includes a MEMS die 102 (including a diaphragm 104 and a back plate 106). The MEMS die 102 is disposed on a substrate 108. An application specific integrated circuit (ASIC) 110 is disposed on the substrate 108. The ASIC 110 is coupled to the MEMS die 102 by a wire 112. A cover 114 encloses the MEMS die 102 and the ASIC 110. A port 116 extends through the cover 114 making this a top port device.

In one aspect, the diaphragm 104 is constructed with stiffeners as described elsewhere herein. In one example of the operation of the microphone 100, sound enters the port 116. The sound moves the diaphragm 104. This causes a changing electrical potential with the back plate 106. This creates an electrical signal that is sent to the ASIC 110. This voltage can be sent out of the substrate 108. In this respect, customers may couple their electronics to pads in the substrate 108. Customer applications include cellular phones or personal computers to mention two examples. Other examples are possible.

Referring now to FIG. 2, another example of a microphone 200 is described. The microphone 200 includes a MEMS die 202 (including a diaphragm 204 and a back plate 206). The MEMS die 202 is disposed on a substrate 208. An ASIC 210 is disposed on the substrate 208. The ASIC 210 is coupled to the MEMS die 202 by a wire 212. A cover 214 encloses the MEMS die 202 and the ASIC 210. A port 216 extends through the substrate 208 making this a bottom port device.

In one aspect, the diaphragm 204 is constructed with stiffeners as described elsewhere herein. In one example of the operation of the microphone 200, sound enters the port 216. The sound moves the diaphragm 204. This causes a changing electrical potential with the back plate 206. This creates an electrical signal that is sent to the ASIC 210. This voltage can be sent out of the substrate 208. In this respect, customers may couple their electronics to pads in the substrate 208. Customer applications include cellular phones or personal computers to mention two examples. Other examples are possible.

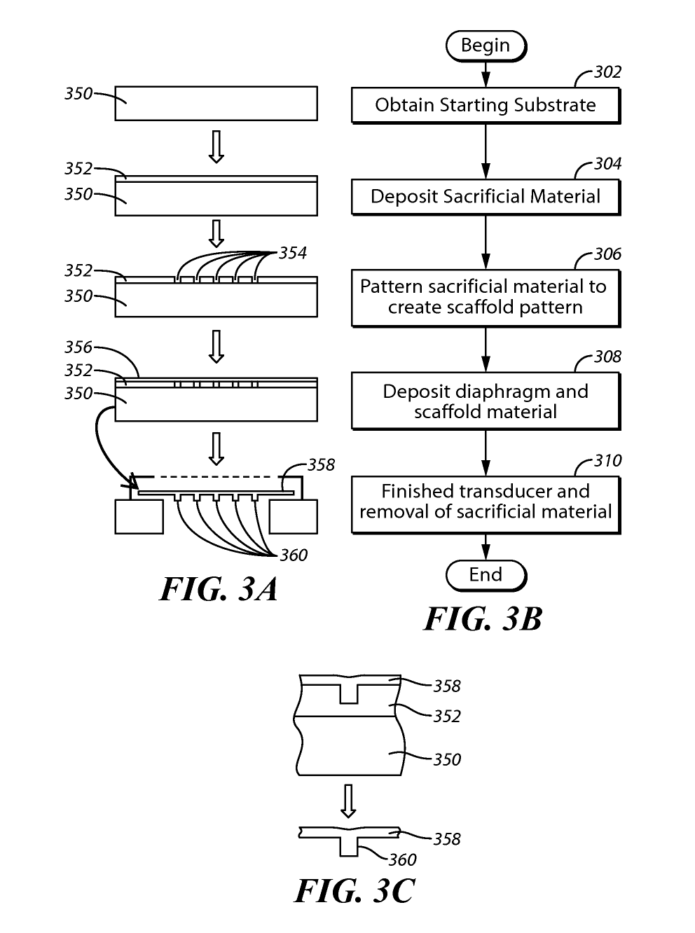

Referring now to FIG. 3, one example of a method of making a stiffened diaphragm is described. At step 302, a starting substrate 350 is obtained. The starting substrate 350 is constructed of a material such as polycrystalline silicon (polysilicon).

At step 304, a sacrificial material 352 such as silicon dioxide is deposited on the substrate 350. At step 306, the sacrificial material 352 is patterned with trenches 354 to create a scaffold pattern. In this step the sacrificial material acts as a kind of mold where the stiffening portions (i.e., the scaffold members) will be formed. In other words, stiffening portions are formed when material is deposited in the trenches 354. The material may be poly-silicon.

At step 308, diaphragm and scaffold material 356 is deposited over the sacrificial material 352 including into the trenches 354. These protrusions are stiffeners are arranged in any suitable pattern.

At step 310, the base 350 and sacrificial material 352 are removed leaving a diaphragm 358. The diaphragm 358 has protrusions 360 that correspond to where material was deposited in the trenches 354.

It will be appreciated that the stiffening pattern of the raised elements (i.e., the scaffolds) can be arranged across or cover the entire or a large percentage of the area of a diaphragm (or selected portions of the diaphragm). Although stiffeners here are shown on one side of the diaphragm, it will be appreciated that they may cover or be positioned on both sides (using an appropriate manufacturing approach). In one example greater than 90% coverage is provided. In another example greater than 95% is provided. Other coverage percentages are possible.

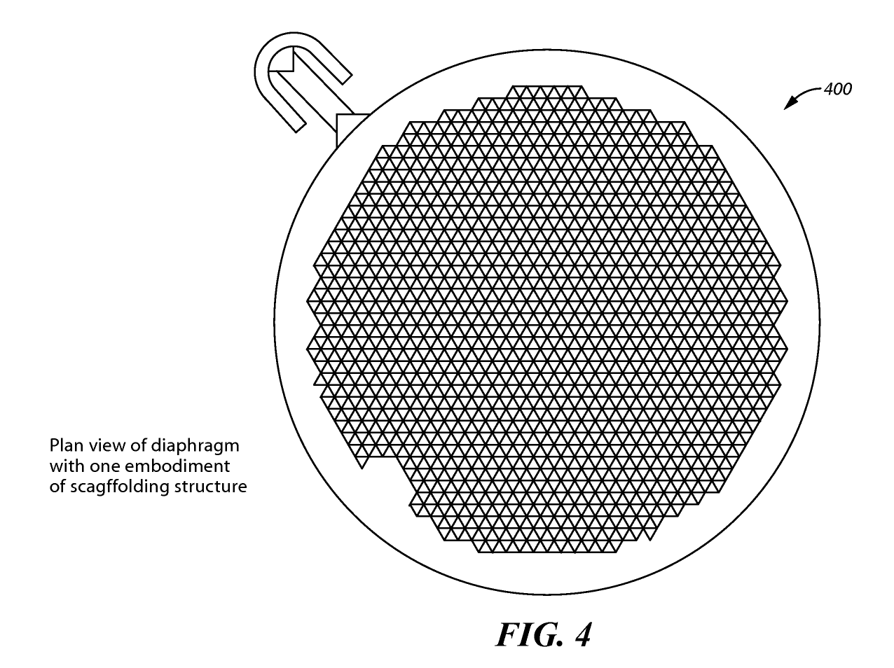

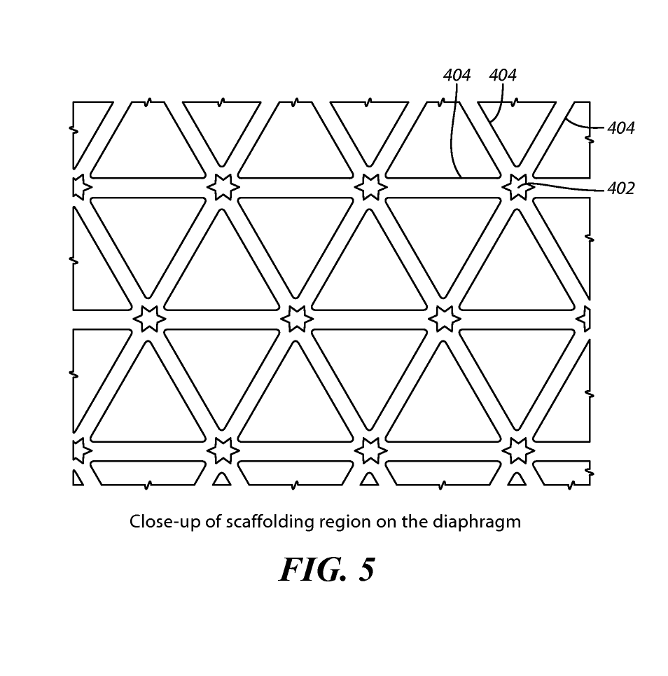

The patterns created by the scaffolds can also vary. Referring now to FIG. 4 and FIG. 5 one example of these patterns is illustrated. A diaphragm 400 includes raised scaffold patterns across approximately 90% of one surface of the diaphragm 400. The patterns include vertices 402 and cross-bars 404. In one example, the cross-bars are approximately 300 microns long, and the protrusions extend 0.5 microns downward from the base of the diaphragm. Other dimensions are possible and may also be used.

In these examples, the protrusions are solid extensions. The diaphragms so formed may be biased at a higher voltage than would normally be possible. Although adding the stiffeners lowers the sensitivity of the microphone, adequate sensitivity can be restored by using a high bias voltage allowing the microphone to be used with greater input sound pressures.

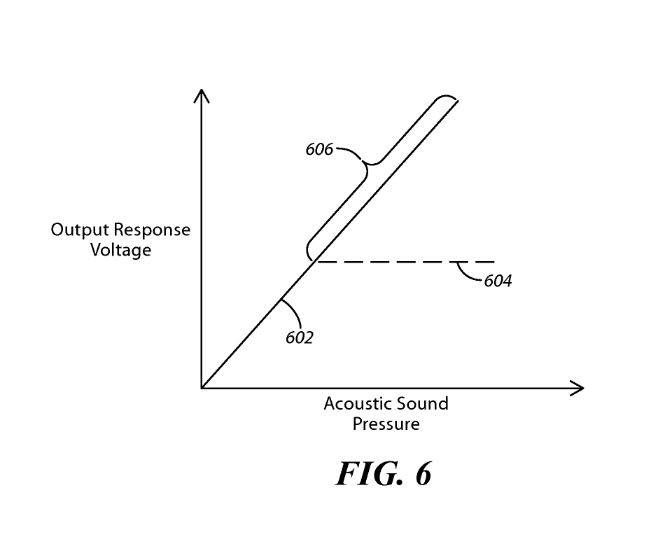

Referring now to FIG. 6, some advantages of the present approaches are described. An input (acoustic sound pressure) is shown along the x-axis. The output response is shown by the y-axis. In low sound pressures the response is linear (line 602). Linear values represent desirable sensitivity. However, at higher sound pressure values previous systems did not have a linear response (line 604). Using the present approaches the linear line 606 is obtained at high sound pressures. The response 606 is linear and desirable. Consequently, the present approaches provide linear responses at both low and high input sound pressures. The approaches provided herein provide the advantages of non-stiffened diaphragm microphones but are able to operate in environments with high input sound pressures. Using the approaches described herein a linear response 606 is obtained in the higher input pressure operating region. This produces a linear and undistorted response that is the type of response that is desired.

In other words, adding the diaphragm stiffening lowers the sensitivity of the acoustic device (e.g., microphone). But, the stiffening allows the bias voltage to be increased. The resultant diagram has the benefits of being thin (e.g., size), but also the benefits of being thick (operating in the large response regions).

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A diaphragm for deployment in a micro electro mechanical system (MEMS) microphone, the diaphragm comprising:
a base portion, the base portion being generally planar and having a first side and a second side;
one or more protrusions that are formed with and extend from the base portion, the protrusions being configured and arranged so as to stiffen the base portion and increase a range of sound pressure levels before distortion occurs.

2. The diaphragm of claim 1, wherein the protrusions are arranged in a scaffold pattern

3. The diaphragm of claim 1, wherein the protrusions are disposed on one of the first side of the diaphragm and the second side of the diaphragm.

4. The diaphragm of claim 1, wherein the protrusions are disposed on both of the first side of the diaphragm and the second side of the diaphragm.

5. The diaphragm of claim 1, wherein the protrusions are disposed over the base portion so as to provide greater than 90 percent coverage over a flexing region.

6. A micro electro mechanical system (MEMS) microphone, the diaphragm comprising:
a back plate;
a diaphragm disposed is proximity to the back plate, the diaphragm comprising:
a base portion, the base portion being generally planar and having a first side and a second side;
one or more protrusions that are formed with and extend from the base portion, the protrusions being configured and arranged so as to stiffen the base portion and increase a range of sound pressure levels before distortion occurs.

7. The MEMS microphone of claim 1, wherein the protrusions of the diaphragm are arranged in a scaffold pattern

8. The MEMS microphone of claim 1, wherein the protrusions of the diaphragm are disposed on one of the first side of the diaphragm and the second side of the diaphragm.

9. The MEMS microphone of claim 1, wherein the protrusions of the diaphragm are disposed on both of the first side of the diaphragm and the second side of the diaphragm.

10. The MEMS microphone of claim 1, wherein the protrusions of the diaphragm are disposed over the base portion so as to provide greater than 90 percent coverage over a flexing region.
